(19) United States
(12) Patent Application Publication
(10) Pub. No.: US 2008/0035839 A1
(43) Pub. Date: Feb. 14, 2008

(54) Radiation Image read-out method

(76) Inventors: Luc Struye, Mortsel (BE); Paul Leblans, Kontich (BE); Jean-Pierre Tahon, Langdorp (BE)

Correspondence Address: NEXSEN PRUET, LLC, P.O. BOX 10648, GREENVILLE, SC, 29603, US

(21) Appl. No.: 11/825,538

(22) Filed: Jul. 6, 2007

Related U.S. Application Data
(60) Provisional application No. 60/844,018, filed on Sep. 12, 2006.

(30) Foreign Application Priority Data
Aug. 10, 2006 (EP) 06120277.6

(51) Int. Cl. G01T 1/105

(52) U.S. Cl. 250/252.1; 250/585

(57) ABSTRACT

In a method of reading out energy stored in a CsBr:Eu stimulable phosphor plate, having been exposed to high energy radiation, said method is performed in two steps: a first read-out step while irradiating said phosphor plate with stimulating energy from an infrared radiation stimulation source, followed by a second read-out step, wherein said second read-out step proceeds while providing stimulation radiation having a higher energy than stimulation radiation energy provided during said first read-out step.

### CROSS-REFERENCE TO RELATED PATENT APPLICATIONS

This application claims the benefit of U.S. Provisional Application No. 60/844,018 filed Sep. 12, 2006, which is incorporated by reference. In addition, this application claims the benefit of European Application No. 06120277.6 filed Sep. 07, 2006, which is also incorporated by reference.

It is understood that the entire contents of all references cited in this specification is incorporated herein by reference.

### FIELD OF THE INVENTION

The present invention relates to a reading out a computed radiography system, making use of specific storage phosphors in order to record X-ray images and more particularly to a technique for reading out said storage phosphor.

### BACKGROUND OF THE INVENTION

In a storage phosphor computed radiography imaging system as described in re-issued U.S. Pat. No. 31,847 a storage phosphor, also known as a stimulable phosphor, is exposed to an X-ray image of an object, such as the body part of a patient, to record a latent X-ray image in the storage phosphor. The latent X-ray image is read out by stimulating the storage phosphor with relatively long wavelength stimulating radiation such as red or infrared light produced by a helium neon gas laser or diode laser. Upon stimulation, the storage phosphor releases emitted radiation of an intermediate wavelength, such as blue light, in proportion to the quantity of X-rays that were received. To produce a signal useful in electronic image processing the storage phosphor is scanned in a raster pattern by a laser beam deflected by an oscillating or rotating scanning mirror or polygon. The emitted radiation from the storage phosphor is reflected by a mirror light collector and detected by a photo detector such as a photomultiplier to produce an electronic image signal. Typically the storage phosphor is translated in a page scan direction past the laser beam which is repeatedly deflected in a line scan direction perpendicular to the page scan motion of the storage phosphor to form a scanning raster patter of a matrix of pixels. The storage phosphor is then erased so that it can be reused again. Successful erasure results in removal of any residual image and any background image noise. Many techniques have been used to erase storage phosphors. Noise erasure techniques and a related apparatus in order to erase a stimulable phosphor sheet, normally proceeds with an erasing source of light having a wavelength range of 400 nm to 600 nm, as e.g. a fluorescent lamp, a laser source, a sodium lamp, a neon lamp, a metal halide lamp or a Xenon lamp, e.g. as disclosed in U.S. Pat. No. 4,496,838. A noise erasing method including sequential first and second erasings, wherein a first erasing is conducted to erase the radiation image previously stored in the storage phosphor and the second erasing is carried out just before the phosphor is to be used again, in order to erase fog which develops after the first erasing has been described in U.S. Pat. No. 4,439,682. So in U.S. Pat. Nos. 5,065,021, 5,422,208 and 5,550,386 erasing of a stimulable phosphor sheet has been disclosed after image read out, by first exposing the storage phosphor to first erasing light having light of wavelengths within the ultraviolet range and then second exposing the storage phosphor to second erasing light having wavelengths longer than the ultraviolet range. In U.S. Pat. No. 5,371,377 a method of storage phosphor erase makes use of light in the wavelength range of 370 nm to 530 nm containing two separate emission bands, one peaking at or near 400 nm (ultraviolet) and the other at or near 500 nm (blue/green). In U.S. Pat. No. 6,140,663 a storage phosphor erase method makes use of a first radiation source having a wavelength of 577 nm to 597 nm while preventing ultraviolet light- the source includes a yellow light emitting diode, and a second radiation source having wavelengths including at least one of infrared or near infrared. U.S. Pat. No. 4,616,135 discloses a storage phosphor erase source including a light emitting diode emitting light in the wavelength range of 728 nm to 850 nm. In recent EP-Application No. 06 118 704, filed Aug. 10, 2006 and corresponding US-Provisional Application U.S. Ser. No. 60/839379, filed Aug. 22, 2006, a method of reading a radiation image, stored in a CsBr:Eu type binderless needle-shaped photostimulable or storage phosphor screen after X-ray exposure of said screen has been described wherein said method comprises the steps of (1) erasing thermally stimulable energy by exposing said screen to infrared radiation in the wavelength range from 1000 nm to 1550 nm; (2) stimulating said phosphor screen by means of stimulating radiation in the range from 550 to 850 nm; (3) detecting light emitted by the phosphor screen upon stimulation and converting the detected light into a signal representation of said radiation image; (4) erasing said phosphor screen by exposing it to erasing light in the wavelength range of 300 nm to 1500 nm.

Although in many patents as e.g. U.S. Pat. No. 7,095,039 a storage phosphor sheet capable of being stimulated by light having wavelengths falling within a visible to infrared region and thereby radiating out the stored energy as emitted light has been described, no explicit description has been found, inclusive for sound examples, indicating particular infrared wavelengths or wavelength ranges within the infrared radiation spectrum, wherein use was made of such infrared radiation in order to read out a storage phosphor plate or panel. An exception however is a sulphide storage phosphor as e.g. samarium doped, further cerium-, europium or terbium-co-doped MgS as in U.S. Pat. No. 4,947,465 wherein a near infrared laser is used in order to read out said storage phosphor as a consequence of the release of trapped electrons characterized by Ce³⁺, Eu²⁺ or Tb³⁺ emission in the case of stimulation by a near infrared laser or of the release of trapped free holes characterized by Sm³⁺ emission in the case of stimulation by a far infrared laser. Otherwise, stimulation as in U.S. Pat. No. 5,569,926 stimulating rays have a wavelength within the range of 700 nm to 900 nm.

Despite the many techniques proposed for reading out a storage phosphor plate, sheet or panel, there is a need for read-out techniques wherein high enough a separation between stimulation radiation and light emitted upon stimulation is possible without the need for stringent requirements with respect to the choice of a suitable filter between both wavelength ranges as e.g. in U.S. Pat. No. 6,495,850, wherein in a method for reading a radiation image that has been stored in a photostimulable phosphor screen, said method comprises the steps of (1) stimulating a photostimulable phosphor screen using at least one source of stimulating radiation; (2) detecting light emitted by the phosphor screen upon stimulation, and converting the light into a signal representation of the image, using an array of transducer elements; and (3) preventing light emitted by the at least one source of stimulating radiation from being detected by the array of transducer elements, wherein photostimulable phosphor screen comprises a divalent europium activated cesium halide phosphor. Filtering means used to prevent light emitted by the at least one source of stimulating radiation from being detected by the array of transducer elements, suitable for use in the said method were said to comprise a dye, wherein the filtering means was further adhered to an output face of a light guiding means for guiding light emitted upon stimulation to the array of transducer elements, or wherein the filtering means was coated onto the photostimulable screen. Further told therein was that the dye should have an absorption spectrum having an absorption peak within the range of 600 to 800 nm, the maximum of the peak attaining a value corresponding with at least 99% absorption, and the absorption in the range of 400 to 500 nm being less than 25%. As examples of filter dyes, a cyanine dye, cryptocyanine, oxatricarbocyanine and sulphonated Cu-phthalocyanine were proposed. In US-A 2006/0030738 further developments were leading to a device comprising a filter or filter layer, provided with at least one organophosphonium divalent transition metal dye, wherein, more in particular said transition metal in said organophosphonium transition metal dye is divalent cobalt or nickel. In US-A's 2006/0027770 in a system for reading out stimulable phosphor screens, plates or panels, filtering means for preventing light emitted by a source of stimulation light from being detected by transducer elements, have a ratio of transmission at the stimulating emission wavelength of a source of stimulation light and transmission of stimulated light in the wavelength range between 350 nm and 500 nm of less than 10⁻⁶, wherein said ratio is defined by the formula Tr(λₛₜ(nm))/Tr(λₓ(nm))<10⁻⁶ wherein λₛₜ is the stimulation wavelength and wherein 350 nm<λₓ<500 nm.

As has been taught in US-A's 2001/0012330 and 2003/0095636 in an apparatus for computed radiography wherein use is made of a storage or photostimulable imaging plate, the signal level is detected by a coarse scan, called a pre-scan, by means of a very weak laser beam, in order to extract the object region, thereby optimizing the scan conditions for a main scan. However, since such processes are done after photographing the object, they are not helpful in optimizing the photographing itself, and, moreover, it is very hard to extract the object region under the influences of e.g. scattered radiation as in a radiographic apparatus. Otherwise as taught in U.S. Pat. No. 5,434,431 in the prior art, such as referred therein, the information, on the basis of which the machine sensitivity is matched to exposure is said to be usually obtained during a “pre-scan”. Benefits of such a preliminary scan of an image, carried out with a reduced resolution in order to save time and with stimulating radiation of reduced intensity in order to perserve the image signal for the main scan, are offset by a loss in throughput and increased mechanical and/or optical complication.

So as in U.S. Pat. No. 4,527,060 a readout system for stimulable phosphor sheets has been in which a preliminary read-out is conducted to analyze the image input information on the phosphor sheet by use of a stimulating radiation beam having an energy lower than the stimulating energy in the final read-out. The image input information from the preliminary read-out is displayed to permit the final read-out and image processing conditions to be set manually or is directly sent to a control circuit for automatically setting them. Preliminary and final read-out sections are formed separately, or a single read-out section is used to conduct both read-out steps. In order to provide a means of acquiring advance information about the signal levels in scanning a photo-stimulable phosphor plate without carrying out a separate preliminary scan and without extra components in the optical path, in a radiation image read-out system in which a stimulable phosphor sheet carrying a radiation image stored thereon is exposed to a scanning stimulating radiation beam which causes the sheet to emit light in the pattern of the stored image and the emitted light is photo-electrically read out, the stimulating radiation is deflected into the main scanning direction by means of galvanometric deflection, a method of acquiring information about signal levels to enable the sensitivity of the read-out to be adjusted is characterized by exposing the sheet to radiation during the retrace step of the galvanometric deflection. Such a method again seems to remain complicated from a point of view of optical as well as mechanical measures.

### SUMMARY OF THE INVENTION

Therefore it is an object of the present invention to simplify the separation between stimulating (stimulation) energy and radiation emitted upon stimulation.

Another object of the present invention is related with less stringent requirements with respect to the optical filter.

The above-mentioned advantageous effects are realized by a method of reading out a photostimulable phosphor plate, having the specific features set out in claim 1.

Specific features for preferred embodiments of the invention are set out in the dependent claims.

So in a method of reading out energy stored in a CsBr:Eu stimulable phosphor plate, having been exposed to high energy radiation, said reading out method is advantageously performed in two steps: a first read-out step while irradiating said phosphor plate with stimulating energy from an infrared (IR) radiation stimulation source, followed by a second read-out step, wherein said second read-out step proceeds while providing stimulation radiation having a higher energy than stimulation radiation energy provided during said first read-out step.

Whereas said phosphor plate has been exposed to high energy radiation from X-rays, α-, β- or γ-rays, or ultraviolet radiation, in one embodiment thereof, said read-out method makes use of an infrared radiation stimulation source emitting radiation energy in a wavelength range of more than 1000 nm, i.e. wherein said infrared radiation stimulation source is a Nd:YAG laser emitting radiation having a wavelength of 1064 nm (i.e. not frequency-doubled); wherein said infrared radiation stimulation source is a Nd:YLF laser emitting radiation having a wavelength of 1053 nm (i.e. not frequency-doubled) or wherein said infrared radiation stimulation source is a diode laser emitting radiation in a wavelength range from 1000 nm up to 1200 nm. In another embodiment the step of detecting radiation emitted upon photostimulation of said phosphor plate proceeds while irradiating said phosphor plate with stimulating energy from an infrared (IR) radiation stimulation source, emitting radiation energy in a wavelength range of more than 1300 nm, and more particularly in a wavelength range of 1350 nm to 1400 nm. Infrared radiation stimulation sources advantageously have a Gaussian intensity distribution profile in order to obtain an optimized sharpness. Added optical devices as prisms, mirrors or lenses or a combination thereof, however, are almost efficient means in order to provide the desired spot dimensions when reading out photostimulable or storage phosphor plates.

Other more particular embodiments of the method of the present invention are following:
an optical filter between said infrared radiation stimulation source and phosphor plate attenuates radiation from said infrared radiation stimulation source in a wavelength range shorter than 800 nm, thereby eliminating harmonics of the laser(s);
separating stimulation radiation and radiation emitted upon stimulation advantageously proceeds by providing optical filters allowing transmission for blue light in an amount of more than 95%;
said higher energy, while performing said second read-out step, is provided by stimulation with radiation energy from a light source emitting light in a wavelength range from 550 nm to 800 nm;
between said first and said second read-out step a calibration procedure is performed in order to allow a second read-out step, provided with an optimized sensitivity of the detector (PMT or CCD) or an optimized power of the laser;
said first and said second read-out step are performed with a different read-out depth in order to obtain an image with a low sensitivity and a high sharpness and an image with a high sensitivity and low sharpness respectively;
an image obtained from a first read-out step and an image obtained from a second read-out step are advantageously combined in one image, i.e., in one “dual energy” image, obtained from digitized energy processing techniques, as e.g. energy subtraction processing, thereby showing an optimal sensitivity and sharpness.

Further advantages and embodiments of the present invention will become apparent from the following description and drawing.

### BRIEF DESCRIPTION OF THE DRAWING

FIG. 1 represents the stimulation spectrum of the shallow traps of a CsBr:Eu phosphor in a storage phosphor panel wherein intensities in the spectrum are given in arbitrary units (A.U.) as a function of stimulating wavelengths. Peak intensities of said stimulating wavelengths thus appear in the wavelength ranges from 1050 nm to 1100 nm and from 1350 nm to 1400 nm, representing ranges wherein stimulation in longer wavelength ranges is most effective.

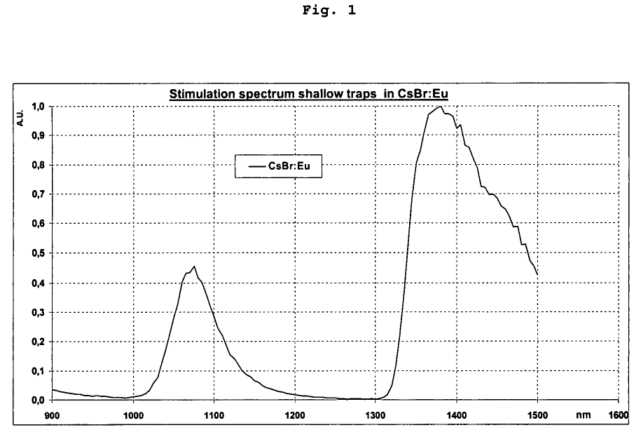

### DETAILED DESCRIPTION OF THE INVENTION

CsBr:Eu storage phosphors are advantageously prepared by mixing CsBr as an alkali metal halide salt and a lanthanide dopant salt in a form of EuX₂, EuX₃, EuOX or EuX_{z}, wherein 2<z<3 and wherein X is one of Br, Cl or a combination thereof. In another embodiment as in U.S. Pat. No. 6,802,991 said CsBr:Eu phosphor is advantageously prepared by mixing CsBr as an alkali metal halide salt and wherein between 10⁻³ and 5 mol % of a Europium compound selected from the group consisting of EuX₂, EuX₃, EuOX, or EuX_{z}, wherein 2<z<3 and wherein X is one of Br, Cl or a combination thereof, firing the mixture at a temperature above 450° C., cooling said mixture, and recovering the CsBr:Eu phosphor. Depending on the inert gas pressure and substrate temperature the crystallinity of the CsBr:Eu phosphor is changed as in US-Applications 2003/0091729 and 2004/0081750. In still another embodiment said CsBr:Eu phosphor is advantageously prepared by mixing CsBr as an alkali metal halide salt and a combination of an alkali metal halide salt and a lanthanide dopant salt according to the formula CsₓEu_{y}X′_{x+αγ}, wherein x/y>0.25, wherein α>2 and wherein X′ is a halide selected from the group consisting of Cl, Br and I and combinations thereof as in US-Applications 2005/0184250, 2005/0184271 and 2005/0186329. CsBr:Eu phosphor screens are advantageously prepared by applying said phosphor on a substrate by a method selected from the group consisting of physical vapor deposition, thermal vapor deposition, chemical vapor deposition, radio frequency deposition and pulsed laser deposition. In that case binderless, needle-shaped phosphors are obtained with a high sensitivity, thanks to the morphology of the crystals, with a high sharpness, as disclosed in U.S. Pat. Nos. 6,967,339 and 6,740,897. Such needle-shaped crystals may also, e.g. after having been ground, be coated in a binder material, such as a polymer or a polymer mixture, in a binder layer of a phosphor screen or panel, as e.g. disclosed in US-Applications 2005/0087707 and 2005/0106490. These very particular CsBr:Eu phosphors are the basic phosphors of storage phosphor screens or panels used in the methods according to the present invention, more details of which are presented hereinafter.

According to the present invention a method is provided of reading out energy stored in a CsBr:Eu stimulable phosphor plate, having been exposed to high energy radiation, wherein said method comprises the step of detecting radiation emitted upon photostimulation of said phosphor plate, wherein said method is performed in two steps: a first read-out step while irradiating said phosphor plate with stimulating energy from an infrared radiation stimulation source, followed by a second read-out step, wherein said second read-out step proceeds while providing stimulation radiation having a higher energy than stimulation radiation energy provided during said first read-out step.

In the method according to the present invention, said phosphor plate has been exposed to high energy radiation from X-rays, α-, β- or γ-rays, or ultraviolet radiation.

According to the method of the present invention, during said first read-out step said infrared radiation stimulation source is a Nd:YAG laser emitting radiation having a wavelength of 1064 nm or a Nd:YLF laser emitting radiation having a wavelength of 1053 nm. Both particular wavelengths are indicating that no use is made of the corresponding frequency-doubled lasers, having only one half of the wavelenghts of both particular lasers respectively. In still another embodiment according to the method of the present invention, said infrared radiation stimulation source is a diode laser emitting radiation in a wavelength range from 1000 nm up to 1200 nm.

In a particular embodiment the method according to the present invention is provided by a first step of reading out energy stored in a CsBr:Eu stimulable (storage) phosphor plate, having been exposed to high energy radiation, wherein said method comprises as a first step of detecting radiation emitted upon photostimulation of said phosphor plate, while irradiating said phosphor plate with stimulating energy from an infrared (IR) radiation stimulation source, emitting radiation energy in a wavelength range of more than 1300 nm.

According to the method of the present invention, said infrared radiation stimulation source advantageously emits radiation energy in a wavelength range from 1350 nm to 1400 nm.

It has been found to be advantageous in the method of the present invention to provide an optical filter between said infrared radiation stimulation source and said phosphor plate in order to attenuate radiation from said infrared radiation stimulation source in a wavelength range shorter than 800 nm as stimulation by radiation having higher energy should be avoided.

In the method according to the present invention, separating stimulation radiation and radiation emitted upon stimulation proceeds by providing one or more optical filter(s) allowing transmission for blue light. According to the present invention said optical filter allows transmission for blue light in an amount of more than 95%, and even up to 100%.

According to the method of the present invention said higher energy, while performing said second read-out step, is provided by stimulation with radiation energy from a light source emitting light in a wavelength range from 550 nm to 800 nm.

Moreover between said first and said second read-out step a calibration step is advantageously performed, according to the method of the present invention, in order to allow performance of said second read-out step with a PMT or a CCD as a detector having an optimized sensitivity or with a laser having an optimized power.

In another aspect of the present invention the method wherein said first and said second read-out steps are performed with a different read-out depth, it is envisaged to obtain an image with a low sensitivity and a high sharpness and an image with a high sensitivity and low sharpness respectively.

It has been found to be advantageous, according to the method of the present invention, when said image obtained from a first read-out step and said image obtained from a second read-out step are combined in one image, more particularly when said image with a low sensitivity and high sharpness and said image with a high sensitivity and low sharpness as set out hereinbefore are combined in one image, i.e. a so-called “dual-energy” image.

Particular advantages related with the method of the present invention, without however limiting the invention thereto, are following.

Separation between stimulation radiation and radiation emitted upon stimulation is simple, in that well-known optical filters as, e.g., the well-known optical filters KG1®, KG3® and KG5®, from SCHOTT AG, Mainz, Germany, can be used as such, as the transmission for blue light, corresponding with light emitted by the CsBr:Eu phosphor upon photostimulation is almost 100%.

Requirements for the optical filters are much less stringent as the photomultiplier used is much less sensitive to radiation in the infrared wavelength ranges as applicable when performing photostimulation.

Due to the low read-out energy used when photostimulating with infrared waves in the regions as set forth, the latent X-ray image remains present in the CsBr:Eu storage phosphor plate as a stored latent image, providing further read-out by radiation having a higher energy as e.g. red (laser) light, e.g. such as with a HeNe-laser at 632 nm.

Capturing of the latent X-ray image after having read out said image by means of infrared rays allows analysis of said image (“pre-scan image”) in order to beforehand allow calibration and to provide an optimized read-out with the said higher read-out energy during a second read-out step, after the first read-out step has been performed with lower (infrared) energy.

While the sensitivity depends on the “hardness” of the X-ray radiation exposure of the storage phosphor plate and while this sensitivity behavior is different for deep traps and for shallow traps, it is possible to combine the image, read-out with the IR-lasers emitting radiation of more than 1000 nm, with the image, read-out with of red laser emitting in a wavelength range between 550 and 800 nm, as e.g. a HeNe laser (emitting at 632 nm) in order to make a system for dual energy.

A lower intensity of light is needed for erasing the plate and to make it ready for re-use, while these IR-stimulable traps are easy to erase.

Scanning may proceed by a flying spot scanner, wherein a photomultiplier (PMT) is used as a detector, as well as by an array of lasers, wherein a CCD is detector. When used in a scanner as e.g. DX-S®, trade name of the needle image plate scanner from Agfa-Gevaert, Mortsel, it is clear that the diode laser, normally present therein and emitting light having a shorter wavelength, must be replaced by a diode laser emitting radiation of a longer wavelength, i.e. in the wavelength range from 1050 to 1150 nm.

As a particularly advantageous aspect, the method of the present invention allows a pre-scan by (far) infrared radiation of a stored X-ray image in a CsBr:Eu storage phosphor plate, thus reading out shallow traps and providing ability to set parameters for a following scan with radiation of higher energy, so that dual energy applications thereby become available.

Having described in detail preferred embodiments of the current invention, it will now be apparent to those skilled in the art that numerous modifications can be made therein without departing from the scope of the invention as defined in the appending claims.

What is claimed is:

1. A method of reading out energy stored in a CsBr:Eu stimulable phosphor plate, having been exposed to high energy radiation, comprises the step of detecting radiation emitted upon photostimulation of said phosphor plate, wherein said method is performed in two steps: a first read-out step while irradiating said phosphor plate with stimulating energy from an infrared radiation stimulation source, followed by a second read-out step, wherein said second read-out step proceeds while providing stimulation radiation having a higher energy than stimulation radiation energy provided during said first read-out step.

2. Method according to claim 1, wherein said infrared radiation stimulation source emits radiation energy in a wavelength range from 1050 nm to 1100 nm.

3. Method according to claim 1, wherein said infrared radiation stimulation source is a Nd:YAG laser emitting radiation having a wavelength of 1064 nm.

4. Method according to claim 1, wherein said infrared radiation stimulation source is a Nd:YLF laser emitting radiation having a wavelength of 1053 nm.

5. Method according to claim 1, wherein said infrared radiation stimulation source is a diode laser emitting radiation in a wavelength range from 1000 nm up to 1200 nm.

6. Method according to claim 1, wherein said infrared radiation stimulation source irradiates said phosphor plate with stimulating energy from an infrared (IR) radiation stimulation source, emitting radiation energy in a wavelength range of more than 1300 nm.

7. Method according to claim 1, wherein said infrared radiation stimulation source irradiates said phosphor plate with stimulating energy from an infrared (IR) radiation stimulation source, emitting radiation energy in a wavelength range from 1350 nm to 1400 nm.

8. Method according to claim 1, wherein said higher energy while performing said second read-out step is provided by stimulation with radiation energy from a light source emitting light in a wavelength range from 550 nm to 800 nm.

9. Method according to claim 1, wherein between said first and said second read-out step a calibration step is performed in order to allow performance of said second read-out step with a PMT or a CCD as a detector having an optimized sensitivity or with a laser having an optimized power.

10. Method according to claim 1, wherein said first and said second read-out step are performed with a different read-out depth in order to obtain an image with a low sensitivity and a high sharpness and an image with a high sensitivity and low sharpness respectively.

11. Method according to claim 1, wherein an image obtained from said first read-out step and an image obtained from said second read-out step are combined in one image.

12. Method according to claim 2, wherein an image obtained from said first read-out step and an image obtained from said second read-out step are combined in one image.

13. Method according to claim 3, wherein an image obtained from said first read-out step and an image obtained from said second read-out step are combined in one image.

14. Method according to claim 4, wherein an image obtained from said first read-out step and an image obtained from said second read-out step are combined in one image.

15. Method according to claim 5, wherein an image obtained from said first read-out step and an image obtained from said second read-out step are combined in one image.

16. Method according to claim 6, wherein an image obtained from said first read-out step and an image obtained from said second read-out step are combined in one image.

17. Method according to claim 7, wherein an image obtained from said first read-out step and an image obtained from said second read-out step are combined in one image.

18. Method according to claim 8, wherein an image obtained from said first read-out step and an image obtained from said second read-out step are combined in one image.

19. Method according to claim 9, wherein an image obtained from said first read-out step and an image obtained from said second read-out step are combined in one image.

20. Method according to claim 10, wherein an image obtained from said first read-out step and an image obtained from said second read-out step are combined in one image.▪
